(19) United States
(12) Patent Application Publication
(10) Pub. No.: US 2014/0152583 A1
(43) Pub. Date: Jun. 5, 2014

(54) OPTIMISTIC PLACEMENT OF USER INTERFACE ELEMENTS ON A TOUCH SCREEN

(71) Applicant: INTERNATIONAL BUSINESS MACHINES CORPORATION, Armonk, NY (US)

(72) Inventors: Paul R. Bastide, Boxford, MA (US); Matthew E. Broomhall, South Burlington, VT (US); Robert E. Loredo, North Miami Beach, FL (US)

(73) Assignee: INTERNATIONAL BUSINESS MACHINES CORPORATION, Armonk, NY (US)

(21) Appl. No.: 13/691,993

(22) Filed: Dec. 3, 2012

(51) Int. Cl. G06F 3/041

(52) U.S. Cl. CPC G06F 3/041
USPC 345/173

(57) ABSTRACT

Optimistic positioning or repositioning of user interface (UI) elements on a touch screen performed by program instructions comprises storing a map of user interaction with a first UI element at a first position on the touch screen, including a force of the user interaction, to identify an area on the touch screen having repeated stress; maintaining a history of user force with the positions on the map; and responsive to the history of user force, moving the position of the first UI element on the touch screen to a second position.

### BACKGROUND

A variety of electronic devices, such as mobile terminals—e.g., smart phones, personal digital assistants, and laptop and tablet computers—include touch screen systems. Various touch screen technologies are available, including resistive, capacitive, surface acoustic wave and infrared technologies. Touch screen systems are relied upon for data input and manipulation. The typical touch screen includes a touch sensitive device that overlies a display screen of the electronic device. The touch sensitive device is operably connected to a computer that receives and processes signals from the touch sensitive device, and is responsive to detection of touches, by e.g., a user's finger or stylus device.

Images, including user interface (UI) elements displayed on the display screen, are viewable through the touch sensitive device. A UI element comprises an image or graphic overlying an area of the electronic device designated as “activated”, such that suitable input (touches) in the activated area are registered as corresponding to activation of the UI element. Often when a user uses touch screen devices to interact with UI elements associated with various applications (“apps”), the repetitive action of interacting with certain UI elements over and over again leads to repeated and focused stress on specific areas of the touch screen. Repeated stress leads to damaged sensors, display systems or electronic subsystems.

Accordingly, there exists a need for a method and system for improved placement of UI elements that distribute wear and stress on a touch screen. Such a method preferably would be easy to implement and would reduce deterioration of the touch screen. The present invention addresses such a need.

### BRIEF SUMMARY

Exemplary embodiments disclose a method, software product and system for improved and optimistic placement or positioning of user interface (UI) elements on a touch screen based on forces applied by users to the touch screen. Aspects of the exemplary embodiment include storing a map of user interaction with a first UI element at a first position on the touch screen, including a force of the user interaction, to identify an area on the touch screen having repeated stress; maintaining a history of user force with the positions on the map; and responsive to the history of user force, moving the position of the first UI element on the touch screen to a second position.

### BRIEF DESCRIPTION OF THE DRAWINGS

FIG. 1 is a logical block diagram illustrating an exemplary system environment for implementing one embodiment of a method for optimistic positioning of user interface (UI) elements on a touch screen based on forces applied by users to the touch screen.

FIG. 2 is a diagram illustrating an exemplary embodiment of a process for optimistic positioning of UI elements on a touch screen based on forces applied by users to the touch screen.

FIG. 3 is a block diagram of a touch screen UI element repositioning system for automatically repositioning UI elements on a touch screen according to one embodiment of the invention.

FIG. 4A is an exemplary screen shot showing a UI element at a first position.

FIG. 4B is an exemplary screen shot showing a UI element at a second position after being repositioned by implementation of a method according to the invention.

### DETAILED DESCRIPTION

The present invention relates to methods and systems for optimistic placement or positioning (or repositioning) of user interface (UI) elements on a touch screen based on forces applied by users to the touch screen. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiments provide methods, computer executable software products and systems for optimistic positioning or repositioning of UI elements on a touch screen based on forces applied by users to the touch screen. Often when a user uses touch screen devices to interact with applications (“apps”) or games, the repetitive action of interacting with certain UI elements over and over again leads to repeated and focused stress on specific areas of the touch screen. Repeated stress may lead to damaged sensors, display systems or electronic subsystems. Moreover, damaged or under-performing sensors may contribute to further performance degradation as deteriorated responsiveness means a user is likely to press harder on the touch screen, further accelerating damage. Thus, methods, software products and systems according to the invention provide or implement methods for positioning or repositioning of UI elements on a touch screen performed by program instructions, the method comprising storing a map of user interaction with a first UI element at a first position on the touch screen, including a force of the user interaction, to identify an area on the touch screen having repeated stress; maintaining a history of user force with positions on the map; and utilizing the map for repositioning the first UI element to a second position on the touch screen. By moving UI elements in this manner, wear on the touch screen is distributed to avoid accelerated wear and stress on areas of the touch screen due to repeated use.

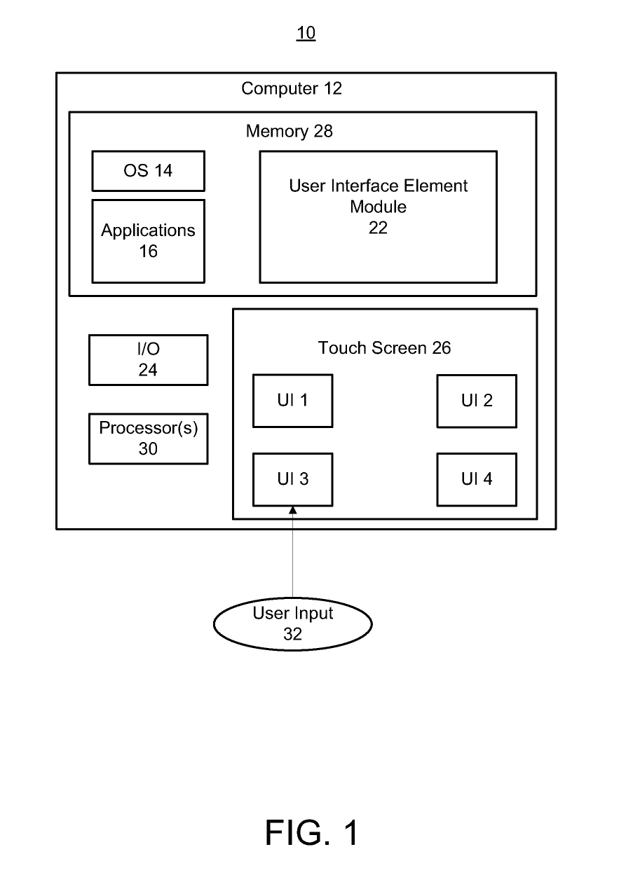

FIG. 1 is a logical block diagram illustrating an exemplary system environment for implementing one embodiment of a method for optimistic placement or positioning of UI elements on a touch screen based on forces applied by users to the touch screen. The system 10 includes a computer 12 having an operating system 14 capable of executing various software applications 16. The software applications 16 are touch screen enabled, which enables the applications be used with a variety of pointing devices, including the user's finger and various types of styluses.

During operation, opening and running the software applications (“apps”) 16 may display objects such as text, video, images and icons in a window, view, or page on touch screen 26. Example types of applications 16 may include a web browser, a word processor, games, map and direction apps, money management apps, email, contacts, phone access and the like. The application 16 that a user of the computer 12 is currently interacting with is said to be the active application or the application that is in focus.

According to an exemplary embodiment, a user interface element (UIE) module is provided that repositions UI elements on a touch screen based on forces applied by users to the touch screen. The UIE module 22 is configured to store a map of user interaction with a first UI element at a first position on the touch screen, including the force of the user interaction, to identify an area on the touch screen having repeated stress; maintain a history of user force with the positions on the map; and responsive to the history of user force, move the position of one or more UI elements on the touch screen.

In one embodiment, the UIE module 22 may be implemented as a standalone application or as a plug-in for the applications 16. In one embodiment, the UIE module 22 automatically repositions a UI element (UI elements 1, 2, 3 and 4 are shown on touch screen 26) in response to a predetermined threshold of repeated force on the UI element; in other embodiments, the UIE module 22 requests permission from the user to reposition a UI element in response to a predetermined threshold of repeated force on the UI element. In some embodiments, the UIE module 22 repositions UI elements that have been used by the user; in alternative or additional embodiments the UIE module 22 determines an initial position of new UI elements. Although UIE module 22 is shown as a single component, the functionality provided by the UIE module 22 may be implemented as more than one module or may be incorporated into an application 16 or the operating system 14.

The computer 12 may exist in various forms, including a personal computer (PC), (e.g., desktop, laptop, or notebook), a tablet, a smart phone, and the like. The computer 12 may include modules of typical computing devices, including input/output (I/O) devices 24. Examples of typical input devices may include keyboard, pointing device, microphone for voice commands, buttons, etc., and an example of an output device is a touch screen 26, displaying UI elements 1, 2, 3 and 4. The computer 12 may further include computer-readable medium, e.g., memory 28 and storage devices (e.g., flash memory, hard drive, optical disk drive, magnetic disk drive, and the like) containing computer instructions that implement the applications 16 and an embodiment of UIE module 22 when executed by a processor.

A data processing system suitable for storing and/or executing program code includes at least one processor 30 coupled directly or indirectly to when one or more memory elements through a system bus. The memory 28 can include local memory employed during actual execution of the program code, bulk storage, and cache memories which provide temporary storage of at least some program code in order to reduce the number of times code must be retrieved from bulk storage during execution.

The I/O devices 24 can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

As an alternative embodiment, the system may be implemented as a client/server model, where a website or application offers optimistic placement, positioning or repositioning of UI elements on a touch screen.

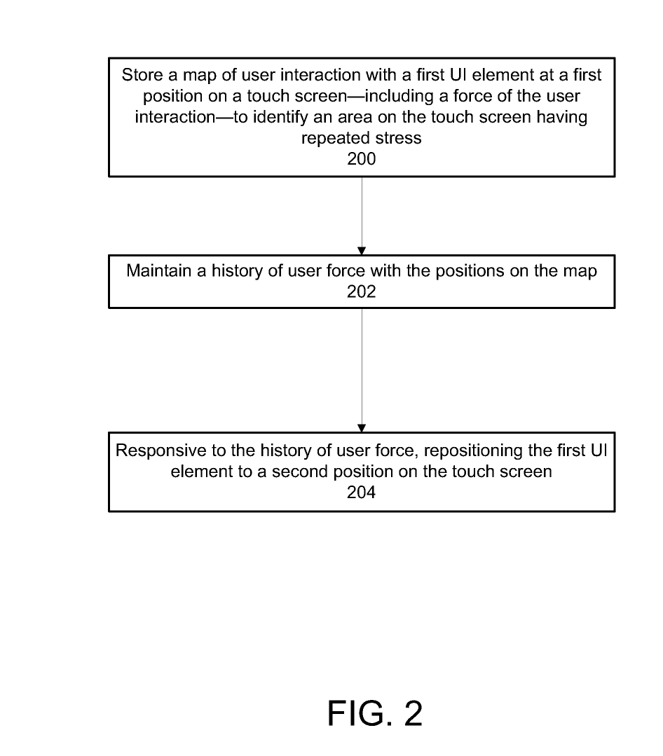

FIG. 2 is a diagram illustrating a process for repositioning UI elements on a touch screen based on forces applied by users to the touch screen. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The process exemplified in FIG. 2 may begin by the UIE module 22 storing a map of user interaction with a first UI element at a first position on a touch screen—including force of the user interaction—to identify an area on the touch screen having repeated stress (step 200). At step 202, a history of user force with positions on the map is maintained. At step 204, responsive to the history of user force, the first position of the first UI element is moved to a second position on the touch screen. It should be noted that in most embodiments, a user will interact with many different UI elements on a device. Some UI elements will be displayed together on a touch screen (such as UI elements for the phone function, email function, calendar function and the like), and some UI elements will be displayed only once an application or “app” is accessed.

The methods, software products and systems of the present invention in some embodiments may be designed to store a map of user interaction with, maintain a history of user force on, and reposition all UI elements used on a touch screen, or in some embodiments may be designed to store a map of user interaction with, maintain a history of user force on, and reposition only a subset of UI elements used on a touch screen, e.g., a subset of the top 5, 10, 15 or twenty most frequently used UI elements.

In some embodiments, the second position of a UI element is placed within a pre-defined area of the first position of the UI element (that is, a position of less stress within a pre-defined area), and in some embodiments the second position of the UI element is placed at an area on the touch screen where overall the map and history indicate a least amount of stress to date. In some embodiments, the touch screen device comprises an accelerometer to quantify force applied to the UI elements; and in some embodiments, the UIE module considers, in addition to force, other factors such elapsed time, number of touches in a pre-defined area and detection of degraded performance at positions on the touch screen. Also, in some embodiments, the methods, software products and systems position new UI elements corresponding to new apps in areas where the map and history indicate a least amount of stress to date.

Some embodiments of the invention comprise the following steps: storing a map of user interaction with a first UI element at a first position on a touch screen—including force of the user interaction—to identify an area on the touch screen having repeated stress; providing additional UI elements on the touch screen; storing a map of user interaction with each UI element, including a force of user interaction with each UI element; maintaining a history of user force with positions on the map; and responsive to the history of user force, the UI elements are repositioned.

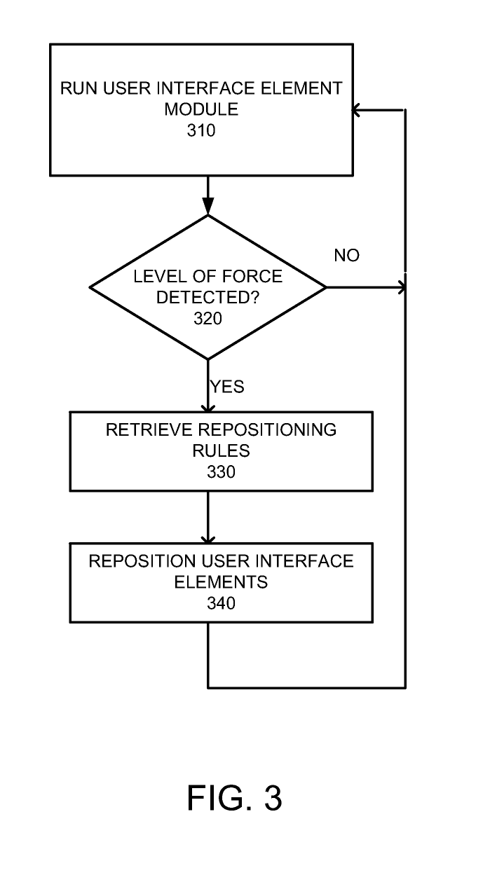

FIG. 3 is a flow diagram of a touch screen UI element repositioning system for automatically repositioning UI elements on a touch screen according to one embodiment of the invention. The processor 30 executes instructions implementing the User Interface Element Module (UIE module) 22 to present UI elements (1, 2, 3 and 4) on the touch screen (step 310). The UIE module 22 detects user force applied to the UI elements and determines the level of force (step 320). If a predetermined level of force is not detected, the UIE module continues to present UI elements 1, 2, 3 and 4 as before. However, if the UIE module detects force upon a UI element that exceeds a predetermined level, the UIE module retrieves repositioning rules that control repositioning of one or more UI elements to another area (step 330). A determination of whether too much force has been applied to positions on the touch screen may be made by one or more repositioning rules that are implemented as policies, and the policies may change depending on the size of the touch screen, the materials that make up the touch screen or estimates parameters regarding the average lifetime of a device. The policies may be automated or designer/development dependent or the user may be allowed access to the policies through, e.g., device settings. The UI elements are then repositioned on the user interface based on the repositioning rules (step 340).

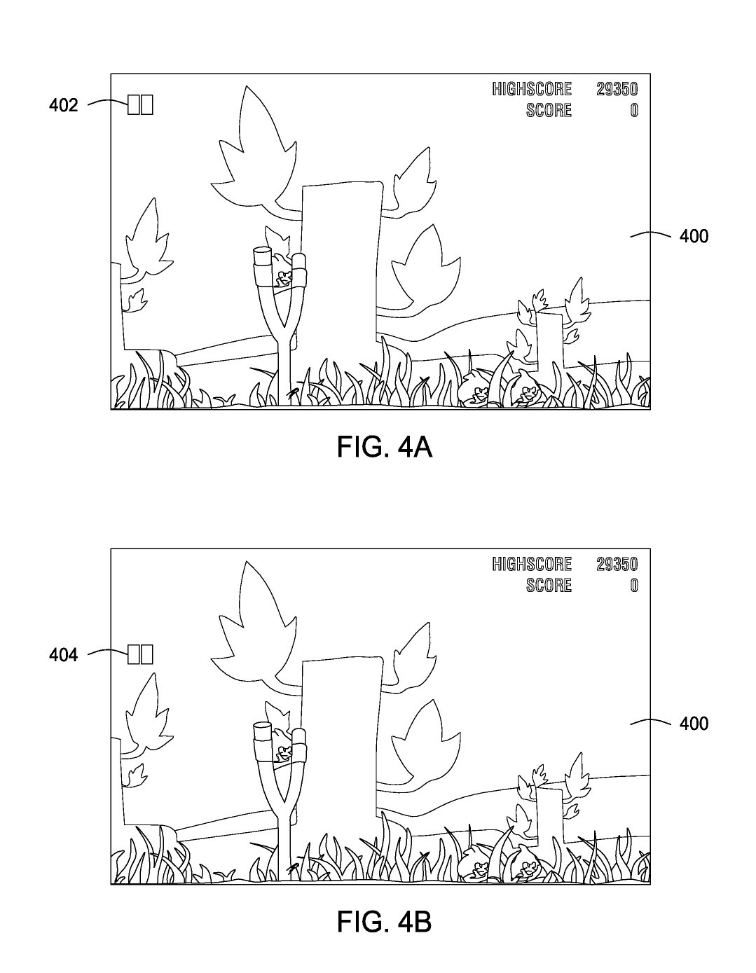

FIG. 4A is an exemplary screen shot showing a UI element at a first position, and FIG. 4B is an exemplary screen shot showing a UI element at a second position after being repositioned by implementation of a method according to the invention. The UI element illustrated here is the “pause button” for a game, e.g., Angry Birds™, a UI element that likely will get a good deal of use from an avid user. In FIG. 4A, the pause button is located close to the top of the touch screen at position 402. Based on the history of force applied to position 402, in FIG. 4B, the pause button is positioned lower at 404 than the pause button in FIG. 4A. In the embodiment shown, the pause button position 404 in FIG. 4B does not overlap the pause button position 402 in FIG. 4A; however, in other embodiments (not shown), a UI element may be placed such that the second position overlaps the first position to some degree. In some embodiments, the UIE module may estimate an expected impact of user interactions with UI elements of a new application. For example, in gaming apps (e.g., Doom Classic™, Scrolling Man™) where the faster a UI element is pressed corresponds to a faster screen movement (such as, e.g., to “fire” ammunition or to move a game element) or in multi-touch design solutions (e.g., OmniGraffle™), the UIE module may determine that a user will act with more force upon certain UI elements, and gradually reposition the UI element over time using overlapping positions.

Systems, software products and methods for optimistic positioning or repositioning of UI elements on a touch screen based on forces applied by users to the touch screen has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for optimistic placement of user interface (UI) elements on a touch screen, the method performed by program instructions executing on a computer having at least one processor, the method comprising:
storing a map of user interaction with a first UI element at a first position on the touch screen, including a force of the user interaction, to identify an area on the touch screen having repeated stress;
maintaining a history of user force with the positions on the map; and
responsive to the history of user force, moving the position of the first UI element on the touch screen to a second position.

2. The method of claim 1, further comprising using the history of user force to adjust placement of the second position for the first UI element within a pre-defined area of the first position.

3. The method of claim 1, further comprising predicting areas of stress on the touch screen based on the history of user force and identifying a position for a second UI element.

4. The method of claim 1, wherein the force of the user interaction on the first UI element is determined using an accelerometer for quantifying force.

5. The method of claim 1, further comprising after the storing step and before the maintaining step:
providing additional UI elements on the touch screen;
storing a map of user interaction with each UI element, including a force of user interaction with each UI element.

6. The method of claim 5, the force of the user interaction on the first UI element is determined using an accelerometer for quantifying force.

7. The method of claim 1, wherein further comprising using a policy regarding touch screen stress to determine the placement of the second position.

8. The method of claim 1, further comprising identifying a position for an additional UI element on the touch screen.

9. The method of claim 1, wherein responsive to the history of user force, the position of one or more UI elements on the touch screen is moved automatically.

10. The method of claim 1, further comprising placing the second position in an area within a pre-determined distance of the first position but with a history of less stress.

11. The method of claim 1, further comprising estimating an expected impact of user interactions with UI elements of a new application, and placing the UI element of the new application in a position with a history of stress commensurate to the estimation.

12. An executable software product stored on a non-transitory computer-readable medium containing program instructions for copying and pasting, the program instructions for:
storing a map of user interaction with a first UI element at a first position on a touch screen, including a force of the user interaction, to identify an area on the touch screen having repeated stress;
maintaining a history of user force with the positions on the map; and
responsive to the history of user force, moving the position of the first UI element on the touch screen to a second position.

13. The executable software product of claim 12, further comprising program instructions for using the history of user force to adjust placement of the second position for the first UI element within a pre-defined area of the first position.

14. The executable software product of claim 12, further comprising program instructions for predicting areas of stress on the touch screen based on the history of user force and identifying a position for a second UI element.

15. The executable software product of claim 12, further comprising program instructions for determining placement of the second position in response to a policy regarding touch screen stress.

16. The executable software product of claim 12, further comprising program instructions for after the storing step and before the maintaining step providing additional UI elements on the touch screen; and storing a map of user interaction with each UI element, including a force of user interaction with each UI element.

17. A system comprising:
a computer comprising a memory, processor and display screen;
and software executing on the computer, the software configured to:
store a map of user interaction with a first UI element at a first position on a touch screen, including a force of the user interaction, to identify an area on the touch screen having repeated stress;
maintain a history of user force with the positions on the map; and
responsive to the history of user force, moving the position of the first UI element on the touch screen.

18. The system of claim 17, wherein the software is further configured to use the history of user force to adjust placement of the second position for the first UI element within a pre-defined area of the first position.

19. The system of claim 16, wherein the software is further configured to determine the placement of the second position in response to a policy regarding touch screen stress.

20. The system of claim 16, wherein the software is further configured to after storing a map and before maintaining a history, providing additional UI elements on the touch screen; and storing a map of user interaction with each UI element, including a force of user interaction with each UI element.
